(19) United States
(12) Patent Application Publication
(10) Pub. No.: US 2023/0140019 A1
(43) Pub. Date: May 4, 2023

(54) DATA COLLECTION DEVICE, DATA ACQUISITION DEVICE, AND DATA COLLECTION METHOD

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Akihito Ito, Inazawa-shi Aichi-ken (JP); Ryo Nakabayashi, Susono-shi Shizuoka-ken (JP); Tatsuya Imamura, Okazaki-shi Aichi-ken (JP); Tomohiro Kaneko, Mishima-shi Shizuoka-ken (JP); Hiroki Murata, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/973,175

(22) Filed: Oct. 25, 2022

(30) Foreign Application Priority Data
Oct. 28, 2021 (JP) 2021-176840

(51) Int. Cl. G06F 17/40

(52) U.S. Cl. CPC G06F 17/40

(57) ABSTRACT

A data collection device collects data from a data acquisition device for acquiring data relating to a person located within a predetermined target area. The data collection device includes a processor for: determining whether data acquired by the data acquisition device is data relating to a resident within the target area; and controlling transmission of data from the data acquisition device to the data collection device. The processor causes the data acquisition device to transmit data of parameters that are at least partially different between a case where data acquired by the data acquisition device relates to a resident and a case where data acquired by the data acquisition device does not relate to a resident.

### CROSS-REFERENCE TO RELATED APPLICATIONS

This application claims priority to Japanese Patent Application No. 2021-176840 filed Oct. 28, 2021, which is incorporated herein by reference in its entirety, including the specification, drawings, and abstract.

### TECHNICAL FIELD

The present disclosure relates to a data collection device, a data acquisition device, and a data collection method.

### BACKGROUND

In smart cities, it has been proposed to collect data from multiple entities within the community. In particular, in JP2013-069084A1, since there is uncertainty in data obtained from information systems of different business entities, it has been proposed to collect data obtained by correcting the obtained data in order to solve the uncertainty.

Incidentally, in a smart city or the like, it is conceivable that data relating to a person located in the smart city is collected from a data acquisition device, and the collected data is used for processing using a machine learning model or training of a machine learning model. However, it is conceivable that a resident residing in a smart city and a visitor not residing in the smart city have different necessary outputs, and thus different machine learning models may be used. In this case, the input parameters to be input to the machine learning model are different between the resident and the visitor. Even in such a case, if the same parameters for the resident and the visitor are collected from the data acquisition device to the data collection device, partially unnecessary data is collected from the data acquisition device, resulting in an increase in the amount of communication between the data acquisition device and the data collection device.

In view of the above problems, an object of the present disclosure is to enable collection of appropriate data for a resident and a visitor while suppressing the amount of communication between a data acquisition device and a data collection device.

### SUMMARY

(1) A data collection device for collecting data from a data acquisition device for acquiring data relating to a person located within a predetermined target area, the data collection device comprising a processor, the processor being configured to:

determine whether data acquired by the data acquisition device is data relating to a resident within the target area; and

control transmission of data from the data acquisition device to the data collection device, wherein

the processor is configured to cause the data acquisition device to transmit, to the data collection device, data of parameters that are at least partially different between a case where data acquired by the data acquisition device relates to the resident and a case where data acquired by the data acquisition device does not relate to the resident.

(2) The data collection device according to above (1), wherein

the data acquisition device is a terminal device held by a person, and

the processor is configured to determine whether or not the data acquired by the data acquisition device is data related to the resident in the target area, based on whether or not the person holding the terminal device is the resident in the target area.

(3) The data collection device according to above (1) or (2), wherein the processor is configured to cause the data acquisition device to transmit data relating to more parameters to the data collection device when the data acquired by the data acquisition device relates to the resident, than when the data acquired by the data acquisition device does not relate to the resident.

(4) The data collection device according to above (3), wherein the parameters for causing the processor to transmit data when the data acquired by the data acquisition device relates to the resident include all parameters for causing the processor to transmit data when the data acquired by the data acquisition device does not relate to the resident, and other parameters.

(5) The data collection device according to any one of above (1) to (4), wherein the processor is configured to cause the data acquisition device to transmit data relating to parameters relating to a current health state of a person to the data collection device, regardless of whether or not the data acquired by the data acquisition device is data relating to the resident.

(6) A data acquisition device for acquiring data relating to a person located in a predetermined target area and transmitting the data to a data collection devices, the data acquisition device comprising a processor, the processor being configured to:

determine whether data acquired by the data acquisition device is data relating to a resident in the target area; and

control transmission of data from the data acquisition device to the data collection device, wherein

the processor is configured to cause the data acquisition device to transmit, to the data collection device, data of parameters that are at least partially different between a case where the data acquired by the data acquisition device relates to the resident and a case where the data acquired by the data acquisition device does not relate to the resident.

(7) A data collection method for collecting data from a data acquisition device for acquiring data relating to a person located within a predetermined target area, the data collection method comprising:

determining whether data acquired by the data acquisition device is data relating to a resident within the target area; and

controlling transmission from the data acquisition device to cause the data acquisition device to transmit data of parameters that are at least partially different between when data acquired by the data acquisition device relates to the resident and when data acquired by the data acquisition device does not relate to the resident.

### BRIEF DESCRIPTION OF THE DRAWINGS

FIG. 1 is a schematic configuration diagram of a machine learning system.

FIG. 2 is a diagram schematically showing a hardware configuration of a terminal device.

FIG. 3 is a functional block diagram of the processor of the terminal device.

FIG. 4 is a diagram schematically illustrating a hardware configuration of a server.

FIG. 5 is a function block diagram of a processor of a server.

FIG. 6 is an operation sequence diagram of data collection processing.

FIG. 7 is a flowchart showing the flow of processing using the machine learning model in the server.

FIG. 8 is a flowchart showing a flow of training processing of the machine learning model in the server.

FIG. 9 is a functional block diagram of the processor of the terminal device according to the second embodiment.

FIG. 10 is an operation sequence diagram of data collection processing according to the second embodiment.

### DESCRIPTION OF EMBODIMENTS

Hereinafter, embodiments will be described in detail with reference to the drawings. In the following description, similar components are denoted by the same reference numerals.

### First Embodiment

### Configuration of the Machine Learning System

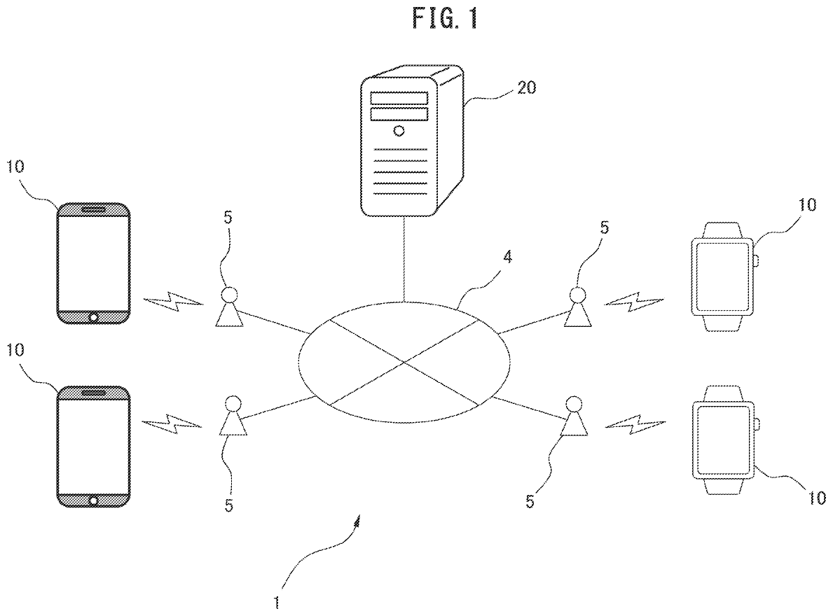

The configuration of the machine learning system 1 according to the first embodiment will be described with reference to FIGS. 1 to 5. FIG. 1 is a schematic configuration diagram of a machine learning system 1. The machine learning system 1 executes the processing using the machine learning model in the server, and trains the machine learning model in the server. The machine learning system 1 also functions as a data collection system that collects data necessary for processing using the machine learning model and training of the machine learning model.

As shown in FIG. 1, the machine learning system 1 includes a plurality of mobile terminal devices 10 and a server 20 capable of communicating with the terminal devices 10. Each of the plurality of terminal devices 10 and the server 20 are configured to be able to communicate with each other, via a communication network 4 configured by an optical communication line or the like and a radio base station 5 connected to the communication network 4 via a gateway (not shown). As the communication between the terminal device 10 and the radio base station 5, various types of wide-area wireless communication having a long communication distance can be used, and for example, communication that conforms to any communication standard such as 4G, LTE, or 5G, WiMAX established by 3GPP, IEEE is used.

In particular, in the present embodiment, the server 20 communicates with the terminal device 10 located within a predetermined target area. The target area is a range surrounded by predetermined boundaries. For example, the target area may be a smart city defined as “a sustainable city or region that solves various problems faced by cities and regions and continues to create new value through the sophistication of management (e.g., planning, maintenance, management, operation, etc.) while utilizing new technologies such as ICT (Information and Communication Technology). The server 20 may be capable of communicating with the terminal device 10 located outside the target area.

The terminal device 10 is an example of a data acquisition device that acquires data necessary for processing using a machine learning model and for training of the machine learning model, which will be described later. In particular, in the present embodiment, the terminal device 10 is a device that is individually held and acquires data of an individual holding the terminal device 10. Therefore, in the present embodiment, the terminal device 10 functions as a mobile data acquisition device that acquires personal data in a predetermined target area or an area around the target area. Therefore, in the present embodiment, the terminal device 10 moves along with the movement of the individual holding the terminal device 10. Therefore, when an individual holding the terminal device 10 moves into the target area, the terminal device 10 held by the individual also moves into the target area. Conversely, when an individual holding the terminal device 10 moves out of the target area, the terminal device 10 held by the individual also moves out of the target area.

Specifically, in the present embodiment, the terminal device 10 includes, for example, a wearable terminal, such as a watch type terminal (smart watch), a wristband type terminal, a clip type terminal, and an eyeglass type terminal (smart glass), or a portable terminal. The terminal device 10 acquires, for example, position information of each individual in the target area and personal data relating to the state of the user wearing the terminal device 10. The personal data includes, for example, vital signs (heart rate, body temperature, blood pressure, and respiration rate), blood oxygen concentration, electrocardiogram (ECG), blood glucose level, step count, calorie consumption, fatigue, sleep state, and the like.

In the present embodiment, the terminal device 10 includes, in particular, a watch type terminal and a portable terminal that communicates with the watch type terminal by short-range wireless communication. As the short-range radio communication, for example, communication conforming to any communication standard (for example, Bluetooth™ or ZigBee™) established by IEEE, ISO, IEC, or the like is used.

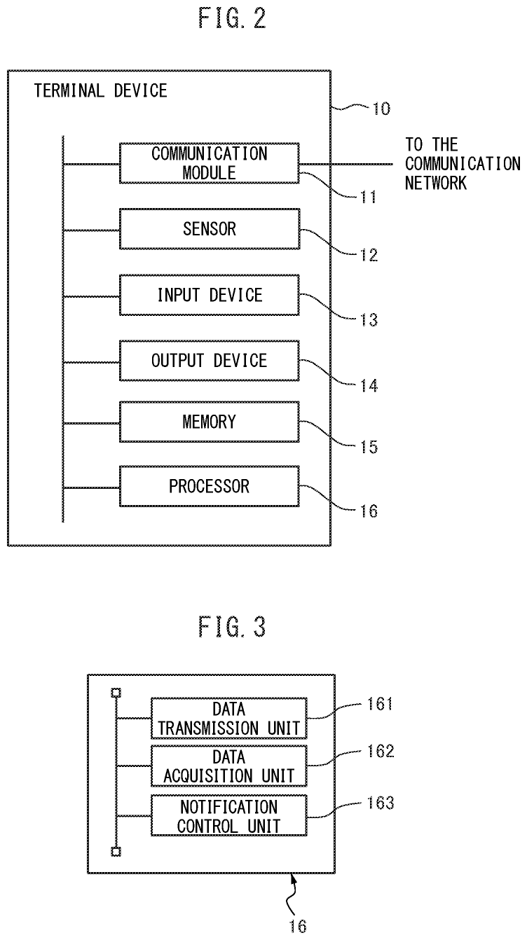

FIG. 2 is a diagram schematically showing a hardware configuration of the terminal device 10. As shown in FIG. 2, the terminal device 10 includes a communication module 11, a sensor 12, an input device 13, an output device 14, a memory 15, and a processor 16. The communication module 11, the sensor 12, the input device 13, the output device 14 and the memory 15 are connected to the processor 16 via signal lines.

The communication module 11 is an example of a communication unit that communicates with other devices. The communication module 11 is, for example, a device for communicating with the server 20. In particular, the communication module 11 is a device that communicates with the radio base station 5 through the wide area wireless communication described above, so that the communication module 11 communicates with the server 20 through the radio base station 5 and the communication network 4.

The sensor 12 detects various parameters relating to the individual holding the terminal device 10. The sensor 12 also detects various parameters, such as parameters relating to the status of the terminal device 10 and the status around the terminal device 10. In particular, the sensor 12 has a plurality of discrete sensors that detect different parameters. The values of the various parameters detected by the sensor 12 are transmitted to the processor 16 or the memory 15 via signal lines.

Specifically, the sensor 12 may include a sensor for detecting parameters relating to a user holding the terminal device 10. For example, when the terminal device 10 is a watch type terminal (smart watch), the sensor 12 includes a sensor for detecting personal data (including biometric data) of a user wearing the terminal device 10. In addition, the sensor 12 may include a sensor for detecting the status of the terminal device 10, for example, a GNSS receiver for detecting the current position of the terminal device 10. The sensor 12 may also include a sensor that detects environmental data around the terminal device 10. For example, the terminal device 10 may include a sensor that detects air temperature or humidity around the terminal device 10.

The input device 13 is a device for the user of the terminal device 10 to use to input information. Specifically, the input device 13 includes a touch panel, a microphone, a button, a dial, or the like. Information input via the input device 13 is transmitted to the processor 16 or the memory 15 via a signal line.

The output device 14 is a device for the terminal device 10 to use to output information. Specifically, the output device 14 includes a display, a speaker, or the like. The output device 14 performs output based on a command transmitted from the processor 16 via a signal line. For example, the display displays an image on the screen based on commands from the processor 16, the speaker outputs sounds based on commands from the processor 16.

The memory 15 includes, for example, a volatile semiconductor memory (e.g., RAM), a nonvolatile semiconductor memory (e.g., ROM), and the like. The memory 15 stores a computer program for executing various processing by the processor 16, various data used when various processing is executed by the processor 16, and the like.

The processor 16 includes one or more CPUs (Central Processing Unit) and peripheral circuits thereof. The processor 16 may further comprise an arithmetic circuit, such as a logical arithmetic unit or a numerical arithmetic unit. The processor 16 executes various kinds of processing based on a computer program stored in the memory 15. Specific processing executed by the processor 16 of the terminal device 10 will be described later.

FIG. 3 is a functional block diagram of the processor 16 of the terminal device 10. As shown in FIG. 3, the processor 16 of the terminal device 10 includes a data transmission unit 161, a data acquisition unit 162, and a notification control unit 163. These functional blocks of the processor 16 of the terminal device 10 are functional modules implemented, for example, by a computer program running on the processor 16. Alternatively, the functional blocks included in the processor 16 may be dedicated arithmetic circuits provided in the processor 16. The details of each of these functional blocks will be described later.

The server 20 is connected to a plurality of terminal devices 10 via the communication network 4. In the present embodiment, the server 20 executes processing using the machine learning model and trains the machine learning model. The server 20 also functions as a data collection device that collects data necessary for execution of processing using the machine learning model and training of the machine learning model.

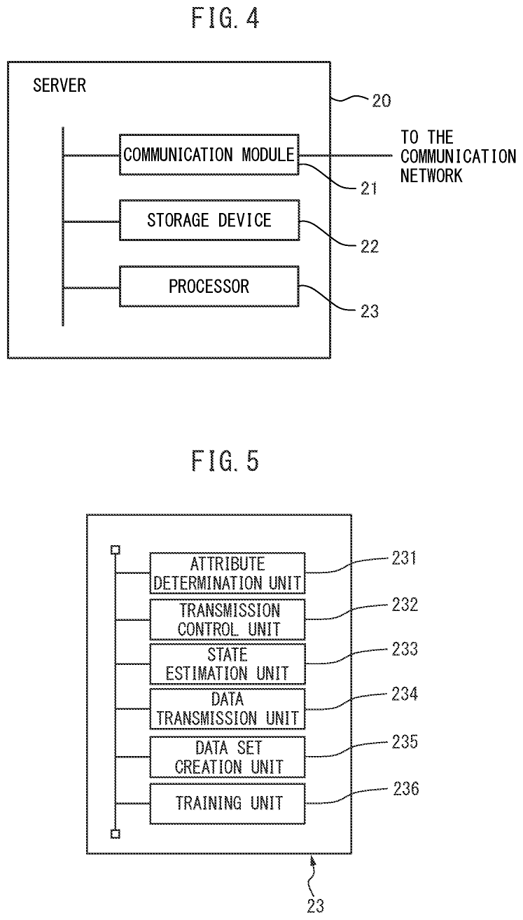

FIG. 4 is a diagram schematically showing a hardware configuration of the server 20. The server 20 includes a communication module 21, a storage device 22, and a processor 23, as illustrated in FIG. 4. The server 20 may include input devices such as a keyboard and a mouse, and output devices such as a display and a speaker.

The communication module 21 is an example of a communication device for communicating with devices outside the server 20. The communication module 21 has an interface circuit for connecting the server 20 to the communication network 4. The communication module 21 is configured to be able to communicate with each of the plurality of terminal devices 10 via the communication network 4 and the radio base station 5.

The storage device 22 is an example of a storage device for storing data. The storage device 22 includes, for example, a hard disk drive (HDD), a solid state drive (SSD), or an optical recording medium. The storage device 22 may include a volatile semiconductor memory (e.g., RAM), a nonvolatile semiconductor memory (e.g., ROM), or the like. The storage device 22 stores a computer program for executing various processing by the processor 23 and various data used when various processing is executed by the processor 23. In particular, the storage device 22 stores data received from the terminal device 10, data related to the machine learning model (e.g., configuration of the machine learning model and learning parameters (e.g., weights, biases, etc.)), data used for processing using the machine learning model, and data used for training the machine learning model.

The processor 23 has one or a plurality of CPUs and peripheral circuits thereof. The processor 23 may further have an arithmetic circuit such as a GPU or a logical or numerical unit. The processor 23 executes various kinds of processing based on a computer program stored in the storage device 22.

FIG. 5 is a functional block diagram of the processor 23 of the server 20. As shown in FIG. 5, the processor 23 includes an attribute determination unit 231, a transmission control unit 232, a state estimation unit 233, a data transmission unit 234, a data set creation unit 235, and a training unit 236. These functional blocks of the processor 23 of the server 20 are, for example, functional modules implemented by computer programs running on the processor 23. Alternatively, the functional blocks included in the processor 23 may be dedicated arithmetic circuits provided in the processor 23. The details of each of these functional blocks will be described later.

### Machine Learning Model

In the present embodiment, a machine learning model subjected to machine learning is used when a predetermined process is performed in the server 20. In the present embodiment, the machine learning model is a model for outputting information on the health of an individual holding the terminal device 10, based on data transmitted from the terminal device 10. Information about an individual's health may include, for example, whether the health state of an individual is abnormal, the lifestyle of an individual to improve, a predicted cholesterol level of the individual, etc. The personal health information output in this manner from the server 20 is transmitted to the terminal device 10 held by the individual and notified to the individual.

In particular, in the present embodiment, a plurality of machine learning models are stored in the server 20, and the input parameters and the output parameter are different for each machine learning model. However, in any machine learning model, at least a part of the input parameters include the data transmitted from the terminal device 10. In the present embodiment, a first machine learning model and a second machine learning model are stored in the server 20. The first machine learning model outputs whether or not an abnormality occurs in the health state of an individual holding the terminal device 10, based on data transmitted from the terminal device 10 or the like. On the other hand, the second machine learning model outputs a lifestyle to be improved, a predicted value of cholesterol, and the like of an individual holding the terminal device 10 based on data and the like transmitted from the terminal device 10.

Further, in the present embodiment, personal data of the user holding the terminal device 10 (in particular, biometric data) and surrounding environment data of the terminal device 10 are input as input parameters to these machine learning models. Data relating to the body of the user holding the terminal device 10 and environment data are acquired from the sensor 12 of the terminal device 10. Alternatively, the environmental data may be obtained, not from the sensor 12, but from another server distributing the temperature and humidity of each location via the communication network 4. In the present embodiment, when some personal data (for example, data including vital signs, blood oxygen concentration, electrocardiogram, etc.; hereinafter referred to as “first personal data”) and environmental data are input to the first machine learning model, whether or not an abnormality has occurred in the health state of the individual is output. On the other hand, when some or all of the personal data (for example, including data relating to parameters such as blood glucose level, calorie consumption, fatigue degree, etc., in addition to the parameters included in the first personal data; hereinafter referred to as “second personal data”) that are at least partially different from the first personal data is input to the second machine learning model, the lifestyle of the individual to be improved, predicted values of cholesterol, etc., are output.

Various machine learning algorithms can be used for the machine learning model. In the present embodiment, the machine learning model is a model trained by supervised learning, such as a neural network (NN), a support vector machine (SVM), and a decision tree (DT). In particular, in the present embodiment, the machine learning model may be a recurrent neural network (RNN) model in which personal data and environment data of a user are input as input parameters in time series.

In the present embodiment, the training of the machine learning model as described above is performed by the server 20. The machine learning model is trained using a training data set. The training data set includes data used as input parameters and ground truth data (ground truth value or ground truth label) of output parameters corresponding to the data. In particular, in the present embodiment, the training data set of the first machine learning model includes time series data acquired by the terminal device 10 for a certain subject, and data on whether or not an abnormality, such as heat stroke, has occurred in the subject. In the present embodiment, the training data set of the second machine learning model includes time series data acquired by the terminal device 10 for a certain subject, data of lifestyle-related diseases occurring in the subject, actual measured values of cholesterol of the subject, and the like. The training data set may be generated by performing preprocessing (e.g., processing for missing data, normalization, standardization, etc.) on the output value of the sensor 12.

In training (learning) of the machine learning model, for example, using any known technique (e.g., an error back propagation method), model parameters in the machine learning model (parameters whose values are updated by training, such as weights w and biases b of NN) are updated repeatedly. The model parameters are repeatedly updated so that, for example, the difference between the output value of the machine learning model and the ground truth value of the output parameter included in the training data set becomes small. As a result, the machine learning model is trained, and a trained machine learning model is generated.

### Processing in the Machine Learning System

In the present embodiment, mainly in the terminal device 10, data necessary for processing using the machine learning model and training of the machine learning model is acquired. The server 20 collects data acquired by the terminal devices 10. In particular, in the present embodiment, data is collected from the terminal device 10 located in the target area.

Here, as described above, the first machine learning model outputs whether or not an abnormality has occurred in the health state of the individual. Whether or not an abnormality has occurred in the health state of the individual can be estimated if there is first individual data or environmental data in a relatively short period of time. On the other hand, as described above, the second machine learning model outputs predicted values of lifestyle, cholesterol, and the like to be improved by the individual. In order to estimate the lifestyle and cholesterol to be improved for an individual, the second individual data for a longer period of time is required. The server 20 can only collect data in a relatively short period of time for visitors who temporarily come into the target area (i.e., visitors who do not reside in the target area). On the other hand, the server 20 can collect data for a long period of time for a resident who resides in the target area.

For this reason, in the present embodiment, the server 20 estimates whether or not an abnormality has occurred in the health state of an individual by using only the first machine learning model for the visitor, based on the personal data and the environment data collected from the terminal device 10 held by the visitor. The estimation result is transmitted from the server 20 to the terminal device 10, and the terminal device 10 notifies the user based on the estimation result.

On the other hand, the server 20 estimates whether or not an abnormality has occurred in the health state of an individual for a resident using the first machine learning model, based on personal data and environment data collected from the terminal device 10 held by the resident, and estimates the lifestyle, cholesterol, and the like of the individual to be improved using the second machine learning model. The estimation result is transmitted from the server 20 to the terminal device 10, and the terminal device 10 notifies the user based on the estimation result.

### Data Collection

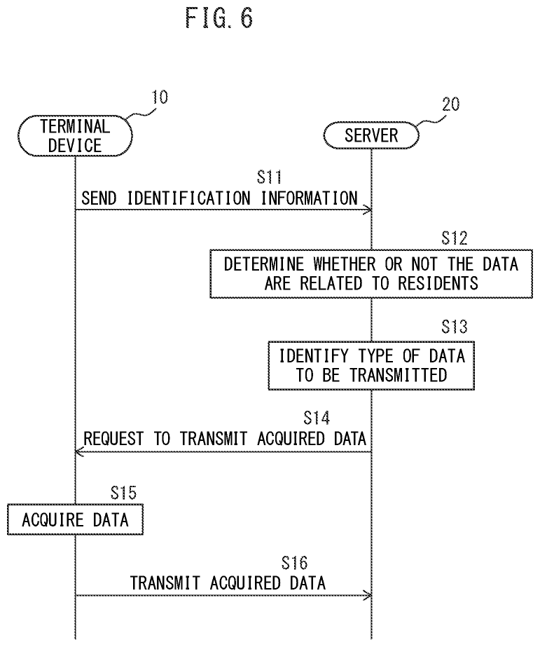

Next, a description will be given of collecting data from the terminal device 10 by the server 20, with reference to FIG. 6. FIG. 6 is an operation sequence diagram of data collection processing. In the present embodiment, data acquired by the terminal device 10 located in the target area is transmitted to the server 20. In particular, in the present embodiment, in the terminal device 10 held by the visitor in which estimation is performed only by the first machine learning model, only the first personal data and the environment data among the acquired data are transmitted to the server 20. On the other hand, in the terminal device 10 held by the resident in which the estimation is performed by the first machine learning model and the second machine learning model, the second personal data and the environment data among the acquired data are transmitted to the server 20. In collecting data from the terminal device 10 by the server 20, the data transmission unit 161 and the data acquisition unit 162 of the processor 16 of the terminal device 10 are used, and the attribute determination unit 231 and the transmission control unit 232 of the processor 23 of the server 20 are used.

As shown in FIG. 6, in collecting data, first, the data transmission unit 161 of the terminal device 10 transmits identification information of the terminal device 10 to the server 20 (Step S11). The identification information of the terminal device 10 may be an identification number assigned to each terminal device 10, or may be identification information associated with a user of the terminal device 10, such as a mail address of a user of the terminal device 10. The identification information is transmitted from the terminal device 10, for example, when the terminal device 10 intrudes into the target area from outside the target area. The transmission of identification information from the data transmission unit 161 to the server 20 is performed via the communication network 4.

Upon receiving the identification information from each terminal device 10, the attribute determination unit 231 of the server 20 determines whether or not the data acquired by the terminal device 10 that transmitted the identification information, is data related to the resident (Step S12). In the present embodiment, the attribute determination unit 231 determines whether or not the data acquired by the terminal device 10 is data related to a resident, based on whether or not the user holding the terminal device 10 is a resident. Specifically, when the user holding the terminal device 10 is a resident, the attribute determination unit 231 determines that the data acquired by the terminal device 10 is data related to the resident. On the other hand, when the user holding the terminal device 10 is not a resident (i.e., is a visitor), the attribute determination unit 231 determines that the data acquired by the terminal device 10 is not data related to a resident.

The identification information of the resident is registered in advance and stored in the storage device 22 of the server 20. Therefore, the attribute determination unit 231 checks the identification information stored in the storage device 22 of the server 20 and determines whether or not the user holding the terminal device 10 is a resident. Specifically, when the identification information received from the terminal device 10 conforms to the information stored in the storage device 22 as the identification information of the resident, the attribute determination unit 231 determines that the user holding the terminal device 10 is a resident. On the other hand, when the identification information received from the terminal device 10 does not conform to the information stored in the storage device 22 as the identification information of the resident, the attribute determination unit 231 determines that the user holding the terminal device 10 is not a resident.

When it is determined whether or not the data acquired by the terminal device 10 is data relating to a resident, the transmission control unit 232 which controls the transmission of the data from the terminal device 10 to the server 20 specifies the type of data to be transmitted by each terminal device 10 to the server 20 (Step S13). In the present embodiment, specifically, when it is determined in step S12 that the data acquired by the terminal device 10 is not data related to a resident, the transmission control unit 232 specifies the first personal data and the environment data as the type of data to be transmitted. On the other hand, when it is determined that the data acquired by the terminal device 10 is data related to the resident, the transmission control unit 232 specifies the second personal data different from the first personal data, and the environment data, as the type of the data to be transmitted.

When the type of data to be transmitted from each terminal device 10 to the server 20 is specified in step S13, the transmission control unit 232 requests the terminal device 10 to transmit the specified type of data to the server 20 (Step S14). The transmission of the request signal requesting the transmission from the transmission control unit 232 to the server 20 is performed via the communication network 4.

As described above, in the present embodiment, the transmission control unit 232 causes the terminal device 10 to transmit, to the server 20, data of parameters at least partially different between the case where the data acquired by the terminal device 10 relates to the resident and the case where the data acquired by the terminal device 10 does not relate to the resident.

Here, as described above, in the present embodiment, the second personal data includes, in addition to all the parameters included in the first personal data, data relating to other parameters such as a blood glucose level. Thus, the second personal data is greater than the first personal data, and the second personal data includes data for all parameters contained in the first personal data and data for other parameters.

Therefore, in the present embodiment, when the data acquired by the terminal device 10 relates to the resident, the transmission control unit 232 causes the terminal device 10 to transmit data relating to more parameters to the server 20, as compared with when the data acquired by the terminal device 10 does not relate to the resident. In addition, in the present embodiment, the parameters transmitted by the transmission control unit 232 when the data acquired by the terminal device 10 relates to the resident include all the parameters transmitted by the transmission control unit 232 when the data acquired by the terminal device 10 does not relate to the resident, and other parameters. By transmitting many parameters for the resident from the terminal device 10 to the server 20 in the above manner, it is possible to estimate more parameter values for the resident than for the visitor by the machine learning model.

In the present embodiment, the transmission control unit 232 causes the terminal device 10 to transmit the first personal data to the server 20, regardless of whether or not the data acquired by the terminal device 10 is data relating to a resident. As described above, the first personal data is personal data including vital signs, blood oxygen concentrations, electrocardiograms, and the like, and is used to output whether or not an abnormality has occurred in the health state of an individual using the first machine learning model. In other words, the first personal data can be said to be data relating to parameters relating to the current health state of the individual. Therefore, in the present embodiment, regardless of whether or not the data acquired by the terminal device 10 is data related to the resident, the transmission control unit 232 causes the terminal device 10 to transmit the data related to the parameter related to the current health state of the person to the server 20. As a result, it is possible to estimate whether or not there is an abnormality in the current health state of a person, which may require urgent response, regardless of the resident or visitor.

The data acquisition unit 162 of each terminal device 10 periodically acquires data from the sensor 12 (Step S15). The data acquired by the data acquisition unit 162 includes first personal data, second personal data, and environment data. The data acquisition unit 162 may acquire all the data that can be acquired by the terminal device 10, or may acquire only the type of data that is requested to be transmitted to the terminal device 10 in step S14. Therefore, for example, when the request signal requesting transmission to the server 20 requests transmission of only the first personal data, the data acquisition unit 162 does not need to acquire data not included in the first personal data, such as a blood glucose level. The data acquired by the data acquisition unit 162 is stored in the memory 15.

When the data acquisition unit 162 acquires the data, the data transmission unit 161 transmits the data acquired by the terminal device 10 in step S15 to the server 20 (Step S16). In particular, in the present embodiment, the terminal device 10 transmits data to the server 20 in accordance with a request signal transmitted from the server 20 in step S14. Therefore, when the request signal requesting transmission to the server 20 requests transmission of the first personal data and the environment data, the data transmission unit 161 transmits the first personal data and the environment data to the server 20. The transmitted data is stored in the storage device 22 of the server 20, thus the data acquired by the terminal device 10 is stored in the storage device 22 of the server 20. The data thus stored in the storage device 22 is used for processing using the machine learning model and training of the machine learning model.

### Use of Machine Learning Models

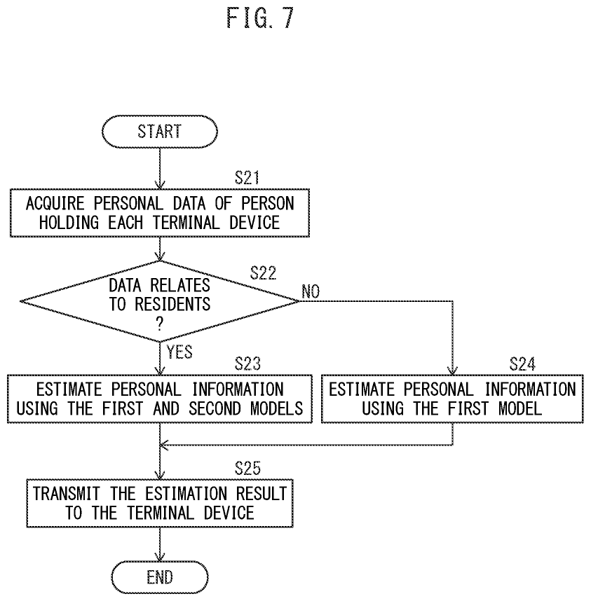

Next, processing using the machine learning model in the server 20 will be described with reference to FIG. 7. In the present embodiment, the server 20 estimates information on the health of an individual holding the terminal device 10 using a machine learning model, based on data transmitted from the terminal device 10. In particular, in the present embodiment, when the individual holding the terminal device 10 is a resident, the server 20 estimates whether or not an abnormality occurs in the health state of the individual holding the terminal device 10, the lifestyle of the individual to be improved, the predicted value of cholesterol of the individual, and the like. On the other hand, when the individual holding the terminal device 10 is not a resident, the server 20 estimates whether or not an abnormality occurs in the health state of the individual holding the terminal device 10. Then, the server 20 transmits the estimation result to the terminal device 10.

FIG. 7 is a flowchart showing a flow of processing using the machine learning model in the server 20. In processing using the machine learning model, the state estimation unit 233 and the data transmission unit 234 of the server 20 are used.

When the data (personal data, environment data, etc.) transmitted from each terminal device 10 is stored in the storage device 22, the state estimation unit 233 acquires data about an arbitrary terminal device 10 from the storage device 22 (Step S21). The state estimation unit 233 acquires data, for example, each time a predetermined amount of data about an arbitrary terminal device 10 is stored.

When obtaining the data for an arbitrary terminal device 10, the state estimation unit 233 determines whether the data acquired by the terminal device 10 is data relating to the resident, based on the identification information of the terminal device 10 (Step S22). This determination is performed in the same manner as in step S12 of FIG. 6.

When it is determined in step S22 that the data acquired by the terminal device 10 is data relating to the resident, the state estimation unit 233 estimates information relating to the health of the individual using the first machine learning model and the second machine learning model (Step S23). Specifically, the state estimation unit 233 inputs the second personal data and the environment data transmitted from the terminal device 10 to the first machine learning model and the second machine learning model, and outputs whether or not an abnormality occurs in the health state of the individual holding the terminal device 10, the lifestyle of the individual to be improved, the predicted value of the cholesterol of the individual, and the like.

On the other hand, if it is determined in step S22 that the data acquired by the terminal device 10 does not relate to the resident, the state estimation unit 233 estimates information on the health of the individual using the first machine learning model (Step S24). Specifically, the state estimation unit 233 inputs the first personal data and the environment data transmitted from the terminal device 10 to the first machine learning model, and outputs whether or not an abnormality occurs in the health state of the individual holding the terminal device 10.

In step S23 or step S24, when the state estimation unit 233 estimates information on the health of the individual holding the terminal device 10, the data transmission unit 234 of the server 20 transmits the estimation result to the terminal device 10 (Step S25). The estimation result is transmitted from the data transmission unit 234 to the terminal device 10 via the communication network 4.

Upon receiving the estimation result from the server 20, the notification control unit 163 of the terminal device 10 controls notification to the user holding the terminal device 10 based on the estimation result. Specifically, when receiving an estimation result indicating that an abnormality occurs in the health state of an individual, the notification control unit 163 causes the output device 14 of the terminal device 10 to output that estimation result. For example, the notification control unit 163 causes the display to display a message indicating that an abnormality occurs in the health state of an individual, or causes the speaker to output the message as an audio signal. In the same manner, the notification control unit 163 notifies the user holding the terminal device 10 of the lifestyle of the individual to be improved, the predicted value of cholesterol of the individual, or the like.

As described above, in the present embodiment, based on whether or not the data acquired by the terminal device 10 is data related to the resident, the values of different parameters are estimated using at least partially different machine learning models, and the estimation result is notified to the user.

### Training of Machine Learning Models

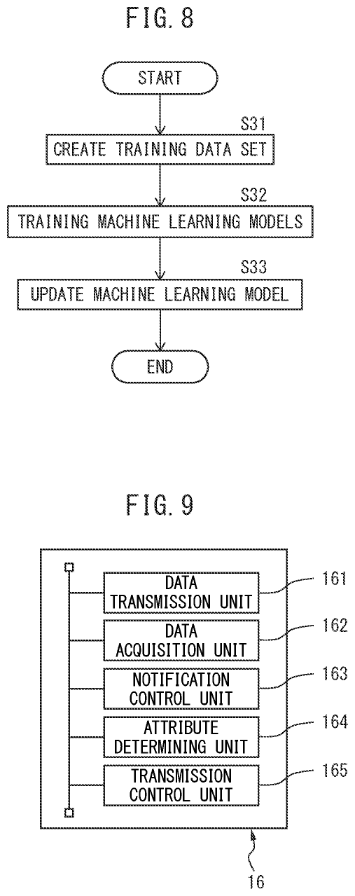

Next, the training process of the machine learning model used in the server 20 will be described with reference to FIG. 8. FIG. 8 is a flowchart showing a flow of training processing of the machine learning model in the server 20. In the training process, the data set creation unit 235 and the training unit 236 of the server 20 are used.

When data (personal data, environmental data, and the like) transmitted from each terminal device 10 is stored in the storage device 22 to some extent, the data set creation unit 235 creates a training data set (Step S31). The training data set includes measured values of input parameters of the machine learning model and ground truth data (ground truth value or ground truth label) of the output parameters. For example, in the present embodiment, the training data set includes data acquired by the terminal device 10 held by each individual, and information on the health of the individual (ground truth data). In particular, in the present embodiment, the training data set used in the first machine learning model includes first personal data and environment data acquired by the terminal device 10 held by the resident and the visitor, and information on the health of the individual (information on the output parameters of the first machine learning model). Similarly, the training data set used for the second machine learning model includes the second personal data and the environment data acquired by the terminal device 10 held by the resident, and information on the health of the individual (information on the output parameters of the second machine learning model).

Data acquired by the terminal device 10 held by each individual is stored in the storage device 22 of the server 20. Therefore, the data set creation unit 235 uses the data stored in the storage device 22 in this manner when creating the learning data set.

Further, in the present embodiment, when each individual suffers from some kind of disease, the information is input to the terminal device 10 by the user himself/herself via the input device 13. The suffering information input to the terminal device 10 is transmitted to the server 20 via the communication network 4. The data set creation unit 235 uses the suffering information as ground truth data when creating the learning data set of the first machine learning model.

In addition, in the present embodiment, the suffering information of the lifestyle-related disease and cholesterol value of the resident are input to the terminal device 10 via the input device 13 by the user himself/herself. The user information input to the terminal device 10 is transmitted to the server 20 via the communication network 4. The data set creation unit 235 uses the user information as the ground truth data when creating the training data set of the second machine learning model.

When a certain number of training data sets are created by the data set creation unit 235 in step S31, the training unit 236 trains the machine learning model using the created training data sets (Step S32). Specifically, as described above, the training unit 236 updates the model parameters used in the machine learning model by using a known error back propagation method or the like.

When the training of the machine learning model is completed, the training unit 236 updates the values of the model parameters of the machine learning model used in steps S23 and S24 of FIG. 7 using the model parameters of the trained machine learning model (Step S33). After the values of the model parameters of the machine learning model are updated, various estimations are performed by the machine learning model using the updated model parameters in steps S23 and S24.

### Effects and Modifications

In the present embodiment, the processing using the second machine learning model is performed only for the resident, and is not performed for the visitor. This is because the processing using the second machine learning model requires data collected over a long period of time to some extent. As described above, in the present embodiment, the transmission control unit 232 causes the terminal device 10 to transmit, to the server 20, data of parameters at least partially different between the case where the data acquired by the terminal device 10 relates to the resident and the case where the data acquired by the terminal device 10 does not relate to the resident. In particular, the data relating to the input parameters of the second machine learning model is not transmitted from the terminal device 10 to the server 20 if the data acquired by the terminal device 10 does not relate to the resident. As a result, unnecessary data is not transmitted from the terminal device 10 to the server 20, therefore, it is possible to collect appropriate data for the resident and visitor while suppressing the communication amount of data between the terminal device 10 and the server 20.

In the above embodiment, the mobile terminal device 10 is used as a data acquisition device for acquiring data necessary for processing using the machine learning model and training of the machine learning model. However, as the data acquisition device, various devices other than mobile terminal devices can be used. Specifically, the data acquisition device may include a sensor disposed in a public area in the target area, for example, a monitoring camera, a sensor for detecting air temperature and humidity or the like. Further, the data acquisition device may include, for example, a sensor disposed in a private area in the target area, for example, a sensor for detecting the power consumption of the electronic device in each facility, a sensor for detecting hot water supply amount by the water heater or the like. Furthermore, the data acquisition device includes a sensor or the like provided in devices to moving in the target area (e.g., an automobile or an electric bicycle).

In the above embodiment, the machine learning model is used to estimate information on the health of an individual holding the terminal device 10, based on the biometric data and the environment data. However, a model having various input parameters and output parameters can be used as the machine learning model. The input parameters may include various parameters that can be acquired by a data acquisition device including the terminal device 10. Specifically, the input parameters may include, in addition to the parameters described above, for example, time, images taken by the mobile terminal device 10 and the monitoring camera or the like, moving images, air temperature in the target area, humidity, weather, wind speed, and the like. The input parameters may also include the power consumption of the electronic devices of each facility in the target area, the amount of hot water supplied by the water heater, and the like. Further, the input parameters may include a destination, a charge, or the like of the device moving within the target area. The output parameters may include, for example, a predicted value of a future power consumption in the entire target area, a predicted value of a future hot water supply amount in the entire target area, or the like. Alternatively, the output parameters may include future predicted values for individuals or individual devices within the target area, such as, for example, information regarding the health of the individual as described above.

However, regardless of which model is used as the machine learning model, the input parameters input to the machine learning model differ between the resident and the visitor. Therefore, in the present embodiment, different data is transmitted from the data acquisition device to the server for processing using the machine learning model and training of the machine learning model.

Further, in the above-described embodiment, the second personal data transmitted from the terminal device 10 to the server 20 when the data acquired by the terminal device 10 is related to the resident includes data on other parameters such as the blood glucose level in addition to all the parameters included in the first personal data transmitted from the terminal device 10 to the server 20 when the data acquired by the terminal device 10 is not related to the resident. However, as long as data of at least partially different parameters is transmitted from the terminal device 10 to the server 20 between when the data acquired by the terminal device 10 is related to a resident and when the data acquired by the terminal device 10 is not related to a resident, the first personal data and the second personal data may each include any parameters.

### Second Embodiment

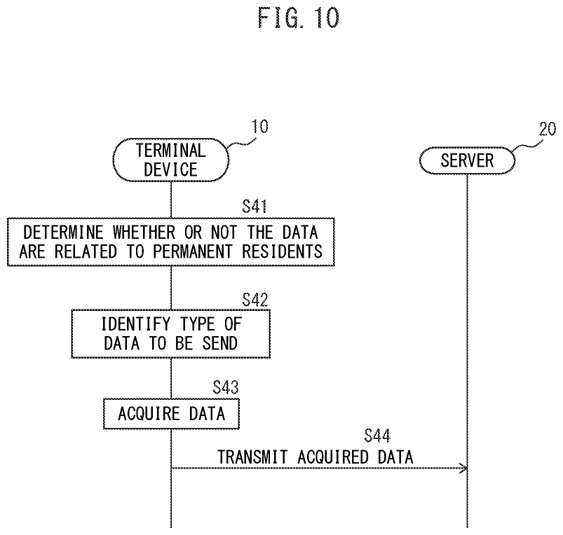

Next, the machine learning system 1 according to the second embodiment will be described with reference to FIGS. 9 and 10. Hereinafter, points different from the machine learning system 1 according to the first embodiment will be mainly described.

In the first embodiment, the server 20 determines whether or not the data acquired by each terminal device 10 is data related to a resident, and the server 20 controls the transmission of data from the terminal device 10 to the server 20 based on the determination result. On the other hand, in the second embodiment, the terminal device 10 determines whether the data acquired by the terminal device 10 is data related to the resident, the terminal device 10 controls the transmission of data to the server 20 based on the determination result.

FIG. 9 is a functional block diagram of the processor 16 of the terminal device 10 according to the second embodiment. As shown in FIG. 9, the processor 16 of the terminal device 10 includes a data transmission unit 161, a data acquisition unit 162, a notification control unit 163, an attribute determination unit 164, and a transmission control unit 165.

FIG. 10 is an operation sequence diagram of data collection processing according to the second embodiment. As shown in FIG. 10, in the present embodiment, when collecting data, the attribute determination unit 164 of the terminal device 10 first determines whether or not the data acquired by the terminal device 10 is data relating to a resident (Step S41). In the present embodiment as well, similarly to step S12 of FIG. 6, the attribute determination unit 164 determines whether or not the data acquired by the terminal device 10 is data related to a resident, based on whether or not the user holding the terminal device 10 is a resident.

In the present embodiment, the attribute determination unit 164 determines whether or not the user holding the terminal device 10 is a resident based on information registered by the user of the terminal device 10 via the input device 13. When the user registers that the user is a resident, the attribute determination unit 164 determines that the user holding the terminal device 10 is a resident. On the other hand, when the user registers that the user is not a resident, or when the user does not register that the user is a resident, the attribute determination unit 164 determines that the user holding the terminal device 10 is a visitor.

When it is determined whether or not the data acquired by the terminal device 10 is data relating to a resident, the transmission control unit 165 of the terminal device 10 identifies the type of data to be transmitted by each terminal device 10 to the server 20, as in step S13 of FIG. 6 (Step S42). If the type of data is specified, the transmission control unit 165 requests the data transmission unit 161 of the terminal device 10 to transmit the specified type of data to the server 20.

The data acquisition unit 162 of each terminal device 10 periodically acquires data from the sensor 12, as in step S15 of FIG. 6 (Step S43). If the data acquisition unit 162 acquires the data, the data transmission unit 161 transmits the data acquired by the terminal device 10 in step S43 to the server 20, as in step S16 of FIG. 6 (Step S44).

In the present embodiment, the terminal device 10 determines whether or not the data acquired by the terminal device 10 is data related to a resident. Therefore, it is possible to reduce the amount of communication between the terminal device 10 and the server 20 that accompanies the determination.

While preferred embodiments of the present disclosure have been described above, the present disclosure is not limited to these embodiments, and various modifications and changes may be made within the scope of the appended claims.

1. A data collection device for collecting data from a data acquisition device for acquiring data relating to a person located within a predetermined target area, the data collection device comprising a processor,
the processor being configured to:
determine whether data acquired by the data acquisition device is data relating to a resident within the target area; and
control transmission of data from the data acquisition device to the data collection device, wherein
the processor is configured to cause the data acquisition device to transmit, to the data collection device, data of parameters that are at least partially different between a case where data acquired by the data acquisition device relates to the resident and a case where data acquired by the data acquisition device does not relate to the resident.

2. The data collection device according to claim 1, wherein
the data acquisition device is a terminal device held by the person, and
the processor is configured to determine whether or not the data acquired by the data acquisition device is data related to the resident in the target area, based on whether or not the person holding the terminal device is the resident in the target area.

3. The data collection device according to claim 1, wherein the processor is configured to cause the data acquisition device to transmit data relating to more parameters to the data collection device when the data acquired by the data acquisition device relates to the resident, than when the data acquired by the data acquisition device does not relate to the resident.

4. The data collection device according to claim 3, wherein the parameters for causing the processor to transmit data when the data acquired by the data acquisition device relates to the resident include all parameters for causing the processor to transmit data when the data acquired by the data acquisition device does not relate to the resident, and other parameters.

5. The data collection device according to claim 1, wherein the processor is configured to cause the data acquisition device to transmit data relating to parameters relating to a current health state of the person to the data collection device, regardless of whether or not the data acquired by the data acquisition device is data relating to the resident.

6. A data acquisition device for acquiring data relating to a person located in a predetermined target area and transmitting the data to a data collection device, the data acquisition device comprising a processor,
the processor being configured to:
determine whether data acquired by the data acquisition device is data relating to a resident in the target area; and
control transmission of data from the data acquisition device to the data collection device, wherein
the processor is configured to cause the data acquisition device to transmit, to the data collection device, data of parameters that are at least partially different between a case where the data acquired by the data acquisition device relates to the resident and a case where the data acquired by the data acquisition device does not relate to the resident.

7. A data collection method for collecting data from a data acquisition device for acquiring data relating to a person located within a predetermined target area, the data collection method comprising:
determining whether data acquired by the data acquisition device is data relating to a resident within the target area; and
controlling transmission from the data acquisition device to cause the data acquisition device to transmit data of parameters that are at least partially different between when data acquired by the data acquisition device relates to the resident and when data acquired by the data acquisition device does not relate to the resident.
